(19) United States
(12) Patent Application Publication
(10) Pub. No.: US 2014/0006476 A1
(43) Pub. Date: Jan. 2, 2014

(54) METHOD FOR PROVIDING N-SCREEN SERVICE USING VIRTUAL AGGREGATION GATEWAY

(71) Applicant: INTELLECTUAL DISCOVERY CO., LTD., Seoul (KR)

(72) Inventors: Eui Nam Huh, Yongin-si (KR); Sang Ho Na, Yongin-si (KR); Jun Young Park, Yongin-si (KR)

(73) Assignee: INTELLECTUAL DISCOVERY CO., LTD., Seoul (KR)

(21) Appl. No.: 13/759,600

(22) Filed: Feb. 5, 2013

(30) Foreign Application Priority Data
Jun. 29, 2012 (KR) 10-2012-0071148

(51) Int. Cl. H04L 29/08

(52) U.S. Cl. CPC H04L 67/26
USPC 709/202

(57) ABSTRACT

Provided are a virtual aggregation gateway and a method of providing an N-screen service using the virtual aggregation gateway. The virtual aggregation gateway may register, to a first terminal, a cloud server that provides a cloud service. The virtual aggregation gateway may access content of the cloud server using registration information provided from the first terminal. When a request for content is received from the second terminal, the virtual aggregation gateway may verify whether the content is shared by the second terminal, and may transform the content to be suitable for the second terminal The virtual aggregation gateway may provide the transformed content to the second terminal.

### CROSS-REFERENCE TO RELATED APPLICATION

This application claims the priority benefit of Korean Patent Application No. 10-2012-0071148, filed on Jun. 29, 2012, in the Korean Intellectual Property Office, the disclosure of which is incorporated herein by reference.

### BACKGROUND

1. Field of the Invention

The following embodiments relate to a method and apparatus for providing an N-screen service, and more particularly, to a virtual aggregation gateway and a method of providing an N-screen service using the virtual aggregation gateway.

2. Description of the Related Art

An N-screen service has been actively developed based on mobile communication companies, terminal manufacturing companies, and the like. Since a variety of companies are independently developing a platform for providing a service, compatibility between N-screen services may be insufficient and severe restrictions on a place may occur based on a platform. Also, due to dependency on a platform and restrictions on a place, a user may not readily use an N-screen service, which results in deteriorating research on an N-screen and development of technology.

Contents may include media such as pictures, motion pictures, files, and the like, which may be played in a terminal

An N-screen service is a service that provides features, such as bi-directional convergence, personalization, and intellectualization of a broadcasting service, and various types of contents and services to various types of wired/wireless terminals of users. The N-screen service may be classified as one of the following three services.

The first service relates to sharing content between various types of wired/wireless terminals, and may provide the same content to wired/wireless terminals having different performance elements. The performance elements may include a screen size, a speed of a central processing unit (CPU), a memory, a codec, a network interface, a network speed, and the like.

Many companies are providing the first service using cloud technology and the like. In the case of providing the first service, technical issues such as a dynamic codec conversion and the like may arise. The dynamic codec conversion is referred to as a one-source multi-use (OSMU) and enables the single same content to be used by a plurality of terminals. A content consumption type spectrum may be expanded through the N-screen service.

The second service relates to providing mobility between terminals, and enables a user to seamlessly view content, which the user has been viewing on one terminal, through another terminal.

For technical solution of the second service, service mobility technology using a profile, network mobility technology through protocol extension, and the like may be employed.

The third service may provide different types of services in interaction with a variety of terminals. For example, when a user is viewing a drama on a television (TV), the third service may enable information on or an advertisement associated with a predetermined scene of the drama to be displayed on a pad or a smart phone of the user. The third service may enable the user to view a left-extended image or a right-extended image of the content using the smart phone or to obtain additional information such as weather information or position information of a stadium appearing in the content, while viewing the content.

To provide different types of services in interaction with a variety of terminals, there is a need to support synchronization technology for interaction.

### SUMMARY

An embodiment provides a virtual aggregation gateway for providing an N-screen service capable of sharing content, which is independent from a platform and has no restriction on a place, and a model for providing a wide-range N-screen service using the virtual aggregation gateway.

According to an aspect, there is provided a method of providing content at a gateway, the method including: receiving a request for sharing the content from a first terminal; setting sharing of the content when a first user of the first terminal has a right to share the content; obtaining the right to share the content from a second terminal of a second user when the first user does not have the right to share the content; receiving a request for providing the content from a third terminal of a third user; creating transformed content by applying, to the content, transformation that is suitable for the third terminal and the content, based on content information on the content; and transmitting the transformed content to the third terminal of the third user.

The second user may be an owner of the content or a user capable of assigning the right to share the content to another user.

The content providing method may further include receiving the content from the first terminal, and storing the received content in a cloud server.

The content may be transmitted from the first terminal to a cloud server via the gateway through synchronization between the first terminal and the gateway.

The content providing method may further include receiving the content from a cloud server. The cloud server may provide a cloud service to the first terminal.

The request for sharing the content, which is received from the first terminal, may include registration information. The gateway may access the cloud server with the right of the first user using the registration information.

The transformed content may be transmitted to the third terminal through a hybrid protocol. The hybrid protocol may be a protocol having a relatively small data transmission amount between a first protocol used when a screen change on the transformed content is great and a second protocol used when the screen change is small.

The first protocol may be a protocol to generate a packet of the content using a motion JPEG (MJPEG) compression, and the second protocol may be a protocol to generate the packet using a remote frame buffer.

According to another aspect, there is provided a gateway, including: a networking unit to receive a request for sharing content from a first terminal; and a processing unit to set sharing of the content when a first user of the first terminal has a right to share the content, and to obtain the right to share the content from a second terminal of a second user when the first user does not have the right to share the content. The networking unit may receive a request for providing the content from a third terminal of a third user and may transmit the transformed content to the third terminal of the third user. The processing unit may create transformed content by applying, to the content, transformation that is suitable for the third terminal and the content, based on content information on the content.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a virtual aggregation gateway (VAG) according to an embodiment;

FIG. 2 illustrates an N-screen service using a VAG according to an embodiment;

FIG. 3 is a flowchart illustrating a method of providing an N-screen service according to an embodiment; and

FIG. 4 is a flowchart illustrating an operation method of a hybrid protocol according to an embodiment.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present invention by referring to the figures.

Various types of services, such as a single platform service, a service for sharing content between devices, an independent service, a hybrid service, and the like, may be provided based on a type of a platform.

The single platform service may provide the same content to a television (TV), a personal computer (PC), and a mobile terminal through a single N-screen service platform.

The service for sharing content between devices may implement an N-screen service by enabling a service to obtain contents, or by enabling contents obtained regardless of a platform to be shared between devices.

In the independent service, a single provider may have a plurality of service platforms and may provide different contents to a plurality of devices based on the repsective service platforms.

The hybrid service may integrate a plurality of platforms and may support an N-screen using a plurality of schemes through networking between devices.

In the following embodiments, disclosed is an N-screen service that may provide all of the single platform service, the service for sharing between devices, and the independent service based on the hybrid service.

A virtual aggregation gateway (VAG) described in the following may provide an N-screen service in an environment in which a thin-client terminal is used.

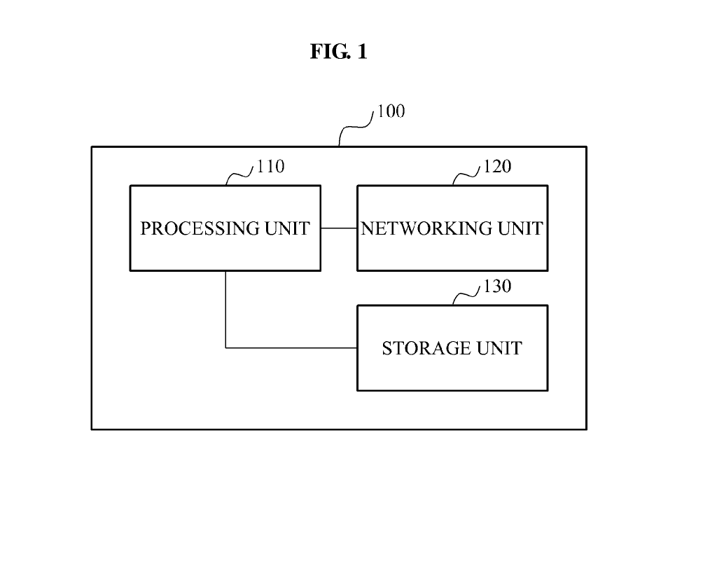

FIG. 1 is a block diagram illustrating a configuration of a VAG 100 according to an embodiment.

Referring to FIG. 1, the VAG 100 may include a processing unit 110, a networking unit 120, and a storage unit 130.

The processing unit 110 may be, for example, a central processing unit (CPU), a system chip, and the like. The processing unit 110 may process a work required for an operation of the VAG 100.

The networking unit 120 may be, for example, a wired or wireless network chip, a networking interface, a networking processor, and the like. The networking unit 120 may process a work required for data transmission and reception of the VAG 100, and may transmit or receive a signal for transmitting and receiving data. The processing unit 110 may control the networking unit 120 to transmit and receive data required for an operation of the VAG 100.

The storage unit 130 may store data required for an operation of the VAG 100.

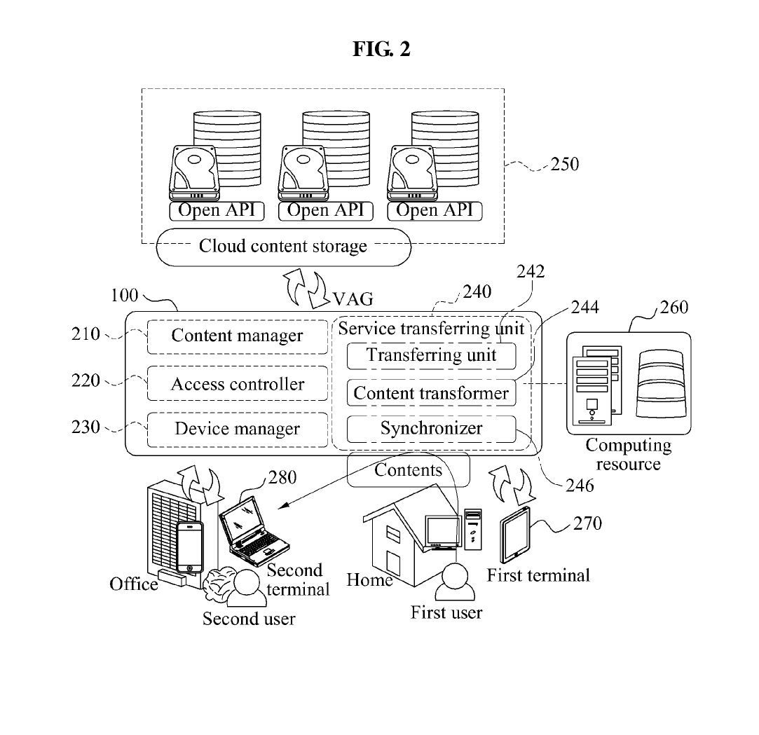

FIG. 2 illustrates an N-screen service using the VAG 100 according to an embodiment.

The VAG 100 may be an inter-layer between a terminal of a user and a cloud server for providing a cloud service. To share content between users or between terminals, the VAG 100 may perform access control, content management, terminal management, service transferring of a service, and the like. Here, transferring of a service may indicate transmitting content that is required for providing the service.

The VAG 100 may execute modules, for example, a content manager 210, an access controller 220, a device manager 230, a service transferring unit 240, a transferring unit 242, a content transformer 244, and a synchronizer 246, in order to provide an N-screen service. Each of the above modules may be executed by the processing unit 110. Data transmission and reception using the modules may be performed by the networking unit 120. For the data transmission and reception, the processing unit 110 may control the networking unit 120.

The content manager 210 may store and provide a list of contents that are held by a user, and may also store and provide content information. Here, the content information may include at least one of a type of the content, a size of the content, information on an owner of the content, and a right about the content. The content information may be separately managed by the user.

The access controller 220 may authenticate a user who desires to access the VAG 100. The access controller 220 may authenticate the user based on an identifier (ID) and a password (PW) that are provided from the user. The access controller 220 may verify information on a terminal. The access controller 220 may collect information on a position of the user.

To share the content, the user may set a right about the content and an access right to access the content with respect to another user. The access right may be a temporary access right. The access controller 220 may provide a method that enables the user to set the above right and the access right with respect to the other user. Through the access controller 220, the user may set the right and the access right with respect to the other user. Also, the user may set a right about content for each group through group management that is provided through the access controller 220.

Another user who does not have a right about content may transmit a request for sharing the content to the user of the content through the access controller 220. The user of the content may determine whether to approve the received request for sharing the content. The user of the content may transmit a response to the received request to the access controller 220. When the response indicates approving the request for sharing the content, the access controller 220 may set sharing of the content with respect to the other user.

The device manager 230 may register a terminal of the user and may store information on the terminal of the user.

A user using an N-screen service may share a plurality of terminals. Accordingly, the device manager 230 may register each of the plurality of terminals and store terminal information on each of the plurality of terminals. The device manager 230 may provide an optimal service based on the terminal information. Here, a service may indicate content and an optimal service may indicate content that is transformed to be suitable for a terminal.

The device manager 230 may register a terminal by classifying the terminal as a mobile type or a fixed type based on a terminal type. The device manager 230 may register a terminal by classifying the terminal as a personal use or a public use based on a terminal use.

The service transferring unit 240 may perform a function for providing content suitable for a terminal based on information on the terminal to transmit the content. Here, the function for providing the suitable content may include resizing of the content, changing of a content resolution, changing of a codec that is used for the content, synchronization between the VAG 100 and the terminal, and the like.

The service transferring unit 240 may include the transferring unit 242, the content transformer 244, and the synchronizer 246.

The transferring unit 242 may transmit, to the terminal, adaptive media that is suitable for the terminal. Here, the adaptive media may indicate the content that is transformed based on terminal information.

The transferring unit 242 may select a content transmission scheme based on a characteristic of the terminal, and may provide a high quality service to the terminal based on the selected content transmission scheme.

The transferring unit 242 may store and manage description or contents of all the services that are provided through the transferring unit 242, and may decrease iterative transcoding by storing or caching a frequently used service or content within the VAG 100.

The content transformer 244 may create transformed content by transforming an attribute of the content based on terminal information. Here, the attribute of the content may include at least one of a size of the content, a resolution of the content, and a codec used for coding ad decoding the content.

The synchronizer 246 may provide content information to the terminal Here, the content may refer to content that is owned by the user of the terminal or content that is shared with another user. Through synchronization of the synchronizer 246, the terminal and the VAG 100 may synchronize content information in real time.

The synchronizer 246 may synchronize local content of the terminal between the terminal and the VAG 100, based on a setting of the user of the terminal. The local content of the terminal may refer to content that is present locally within the terminal Original content may be present within a cloud server, and may be provided to the terminal through the VAG 100 only when a request is received from the user of the terminal

A cloud content storage 250 may indicate a cloud server. A plurality of cloud servers may be present.

The cloud server may provide a cloud service through an open application programming interface (API). The VAG 100 may access content within the cloud server through the open API, may receive the content from the cloud server, and may transmit the content to the cloud server.

Also, the cloud content storage 250 may correspond to the storage unit 130 of the VAG 100 of FIG. 1. For example, the cloud content storage 250 may be, for example, at least one disk, a redundant array of independent disks (RAID), an external storage apparatus, and the like.

A computing resource 260 may be an entity that performs a portion of functions of a service provided by the VAG 100, such as transcoding, for example. The computing resource 260 may be a processor or a processor core within the VAG 100, and may be a computer or a server connected to the VAG 100.

When the cloud content storage 250 and the computing resource 260 are physically separate from the VAG 100, the networking unit 120 may transmit and receive data to and from each of the cloud content storage 250 and the computing resource 260.

The VAG 100 may transmit, to the terminal, the content that is provided from the cloud content storage 250. The terminal may be a mobile terminal such as a smart phone and a thin client, and may be a fixed terminal such as a wall pad and a smart TV. The terminal may register a user ID, a PW, and terminal information to the VAG 100. The VAG 100 may authenticate the user of the terminal based on the user ID, the PW, and the terminal information.

The terminal may be provided with a service from the VAG 100 through various manners, such as an application, a web browser, virtual network computing, and the like. The terminal may interact with the VAG 100 and the cloud content storage 250 through a user interface.

A plurality of terminals may be provided with the content. A single user may have a plurality of terminals, and a plurality of users may share a single terminal For example, user IDs and PWs of the plurality of users may be registered with respect to a public terminal.

FIG. 2 illustrates a first terminal 270 of a first user and a second terminal 280 of a second user. The first user and the second user may be used to indicate a case in which the same user uses terminals of the user at different locations. For example, the first terminal 270 may be a terminal of the user that is used at home, and the second terminal 280 may be a terminal of the user that is used in an office.

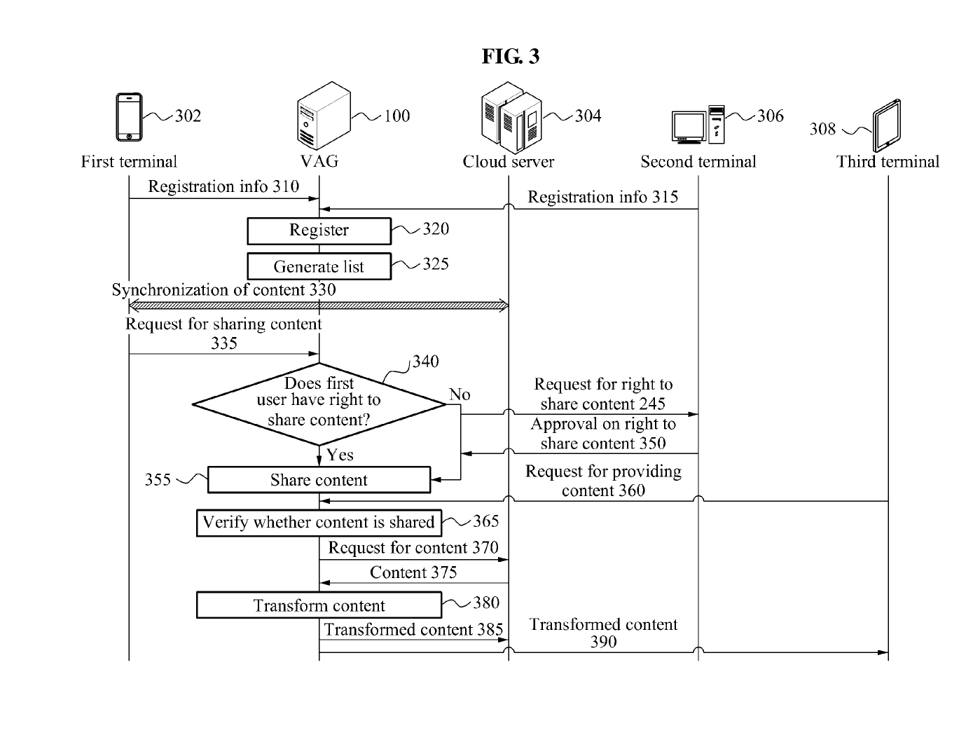

FIG. 3 is a flowchart illustrating a method of providing an N-screen service according to an embodiment.

The N-screen service may be provided to a first terminal 302 and a third terminal 308 through the VAG 100. A second terminal 306 may share content with the first terminal 302 and the third terminal 308. A cloud server 304 may store the content, and may provide the content to the VAG 100. The cloud server 304 may be the cloud content storage 250 of FIG. 2. A plurality of cloud servers 304 may be present. Each of the cloud servers 304 may be a server that is operated by a different cloud service provider.

A user of a terminal may be provided with a service using the VAG 100, independently from a place and a device.

In operation 310, the networking unit 120 may receive registration information from the first terminal 302.

The registration information may include at least one of an ID of a user of the first terminal 302, a PW of the user of the first terminal 302, information on the first terminal 302, and information on a cloud service used by the user of the first terminal 302.

The registration information may be transmitted to the VAG 100 through an application of the first terminal 302 or a browser being executed in the first terminal 302. For example, the user of the first terminal 302 may access the VAG 100 through access to the installed application or browser. The user of the first terminal 302 may join a service provided by the VAG 100 by joining the VAG 100 as a member.

In operation 315, the networking unit 120 of the VAG 100 may receive registration information from the second terminal 306.

In operation 320, the processing unit 110 of the VAG 100 may register the first terminal 302 and/or the user of the first terminal 302 based on at least one of the ID of the user of the first terminal, the PW of the user of the first terminal 302, and information on the first terminal 302. The user may register a plurality of terminals to the VAG 100. A single terminal may be registered as a terminal of the plurality of users.

The processing unit 110 may register the cloud server 304 for providing a cloud service to the first terminal 302, based on the ID of the user of the first terminal 302, the PW of the user of the first terminal 302, information on the first terminal 302, and information on the cloud service used by the user of the first terminal 302. The VAG 100 may register a plurality of cloud servers as the cloud server 304 for providing a service to the first terminal 302. Also, the VAG 100 may register the cloud server 304 for providing a service to a corresponding terminal, with respect to each of the plurality of terminals.

Specifically, the VAG 100 may expand the sharing range of content that is provided through the VAG 100 by registering the cloud server 304 for registering a cloud service to the user of the terminal. The VAG 100 may be provided with the cloud service, such as content and the like, from the cloud server 304 through an open API. The VAG 100 may access the cloud server 304 with a right of the user of the first terminal 302, based on the registration information.

In operation 325, the processing unit 110 may generate a list about the first terminal 302 based on the ID of the user of the first terminal 302, the PW of the user of the first terminal 302, information on the first terminal 302, and information on the cloud service used by the user of the first terminal 302. Here, the list may include at least one of a list of cloud services and a list of sharing users. Information on the cloud service may be information on the cloud server 304 that provides the cloud service to the first terminal 302.

Operations 320 and 325 may also be applied to the second terminal 306. For example, in operation 320, the second terminal 306 and/or the user of the second terminal 306 may be registered, and the cloud server 304 for providing a cloud service to the second terminal 306 may be registered. Also, in operation 325, a list about the second terminal 306 may be generated.

In operation 330, the processing unit 110 may perform content synchronization. Here, the content synchronization may indicate synchronizing the content, stored in at least one of the first terminal 302, the VAG 100, and the cloud server 304, with at least one of the first terminal 302, the VAG 100, and the cloud server 304. For example, through the content synchronization between the first terminal 302 and the VAG 100, local content of the first terminal 302 may be transmitted to the VAG 100 and be stored in the VAG 100. Alternatively, original content within the cloud server 304 may be transmitted to the VAG 100 and be stored in the VAG 100. Alternatively, local content of the first terminal 302 may be uploaded to the cloud server 304.

The content synchronization may include synchronization of content information. Content information may include a right to share the content that is held by the user of the first terminal 302. When a plurality of contents is present, the content information may include a list of contents that the user of the first terminal 302 has a right to share.

Operation 330 may include an operation of receiving, by the networking unit 120, the content from the first terminal 302 and an operation of transmitting, by the networking unit 120, the received content to the cloud server 304 to store the content in the cloud server 304. In operation 330, the content may be transmitted from the first terminal 302 to the cloud server 304 via the VAG 100, through synchronization between the first terminal 302 and the VAG 100.

The above content synchronization may be performed between two or more of the second terminal 306, the VAG 100, and the cloud server 304.

In operation 335, the networking unit 120 may receive a request for sharing the content from the first terminal 302. Here, the request may include first user information indicating a first user that is the user of the first terminal 302. Sharing of the content may indicate sharing the content with a predetermined user, such as a third user of the third terminal 308, for example, and may also indicate sharing the content with a user within a list of sharing users and sharing the content with all of the users.

In operation 340, the processing unit 110 may determine whether the first user has a right to share the content, based on the first user information. When the first user has the right to share the content, operation 355 may be performed. When the first user does not have the right to share the content, operations 345 and 350 may be performed.

When the first user does not have the right to share the content, the processing unit 110 may obtain the right to share the content from the second terminal 306 of the second user in operations 345 and 350. Here, the second user may be an owner of the content, or may be a user capable of assigning, to another user, the right to share the content.

In operation 345, the networking unit 120 may request the second terminal 306 for the right to share the content.

The second user may verify the request for sharing the content, and may determine whether to approve the request.

In operation 350, when the second user approves the request for the right to share the content, the networking unit 120 may receive, from the second terminal 360, the approval on the right to share the content.

When the first user has the right to share the content or obtains the right to share the content from the second terminal 306, the processing unit 110 may set sharing of the content in operation 355. The setting may indicate sharing the content with a predetermined terminal or a predetermined user, such as the third terminal 308 or the user of the third terminal 308.

In operation 360, the networking unit 120 may receive a request for providing the content from the third terminal 308. The above request may include information on the third terminal 308.

In operation 365, the processing unit 110 may verify whether the content is shared with the third terminal 308 or the user of the third terminal 308. When the content is shared with the third terminal 308 or the user of the third terminal 308, operations 370 through 390 may be performed. Otherwise, the procedure may be terminated.

For example, the user of the first terminal 302 may be identical to the user of the third terminal 308. When the user of the first terminal 302 is identical to the user of the third terminal 308, the processing unit 110 may verify whether the third terminal 308 is registered to the VAG 100. On the contrary, when the user of the first terminal 302 is different from the user of the third terminal 308, the processing unit 110 may verify whether the third terminal 308 is registered to the VAG 100 and whether the third terminal 308 or the user of the third terminal 308 may share the content.

When the content is shared with the third terminal 308 or the user of the third terminal 308, operations 365 through 385 may be performed.

When the requested content is absent within the VAG 100, operations 365 and 370 may be performed.

In operation 370, the networking unit 120 may request the cloud server 304 for the content.

In operation 375, the networking unit 120 may receive the content from the cloud server 304. Through operations 370 and 375, the content requested from the third terminal 308 may be transmitted from the cloud server 304 to the VAG 100.

In operation 380, the processing unit 110 may create transformed content by applying, to the content, transformation that is suitable for the third terminal 308 and the content, based on at least one of content information and information on the third terminal 308. For the above transformation, the processing unit 110 may analyze information on the third terminal 308 and the content information.

The transformed content may be stored or cached within the VAG 100. The stored or cached transformed content may be provided to another terminal that is suitable for the transformed content.

In operation 385, the networking unit 120 may transmit the transformed content to the cloud server 304.

In operation 390, the networking unit 120 may transmit the transformed content to the third terminal 308. The third terminal 308 may be provided with an N-screen service by receiving the transformed content.

To be provided with an N-screen service, an apparatus or software for being provided with the N-screen service may be required within a terminal For example, transmitting the transformed content from the VAG 100 to the third terminal 308 may be performed according to the following first to third methods.

The first method refers to a content transmission method using an application. According to the first method, an application may be installed in a terminal and data transmission and reception with the VAG 100 may be performed through the application. Accordingly, performance of the first method may be significantly affected by performance of the terminal. Also, a user of the terminal may need to install the application within the terminal in advance in order to be provided with the N-screen service.

The second method refers to a content transmission method using a web browser. Data transmission and reception with the VAG 100 may be performed through the web browser that is provided as an essential application. The above data transmission and reception may be performed in a web service form such as HTML5. The web browser is an essential application of the terminal and thus, may have no need to be separately installed. Also, HTML5 may basically provide playback of moving pictures, displaying of pictures, and the like. In the case of using the web browser, since resources of the terminal are used, performance of the terminal may affect a service provision.

The third method refers to a content transmission method using a hybrid protocol. For example, in operation 390, the transformed content may be transmitted to the third terminal 308 through the hybrid protocol. The hybrid protocol may be a protocol having a relatively small data transmission amount between a first protocol used when a screen change on the transformed content is great and a second protocol used when the screen change is small. Here, that the screen change is great may indicate that a level of change between adjacent frames of the content is greater than or equal to a predetermined level. That the screen change is small may indicate that the level of change between adjacent frames of the content is less than the predetermined level. The first protocol may be a protocol to generate a packet of the content using a motion JPEG (MJPEG) compression, and the second protocol may be a protocol to generate the packet using a remote frame buffer (RBF).

To provide an N-screen service, virtual network computing (VNC) may be temporarily configured between the VAG 100 and the third terminal 308. The N-screen service may be provided from the VAG 100 to the third terminal 308 through a protocol. The third method uses the VNC and thus, may provide the N-screen service regardless of the terminal performance. Accordingly, the third method may be useful for a thin client having relatively low terminal performance.

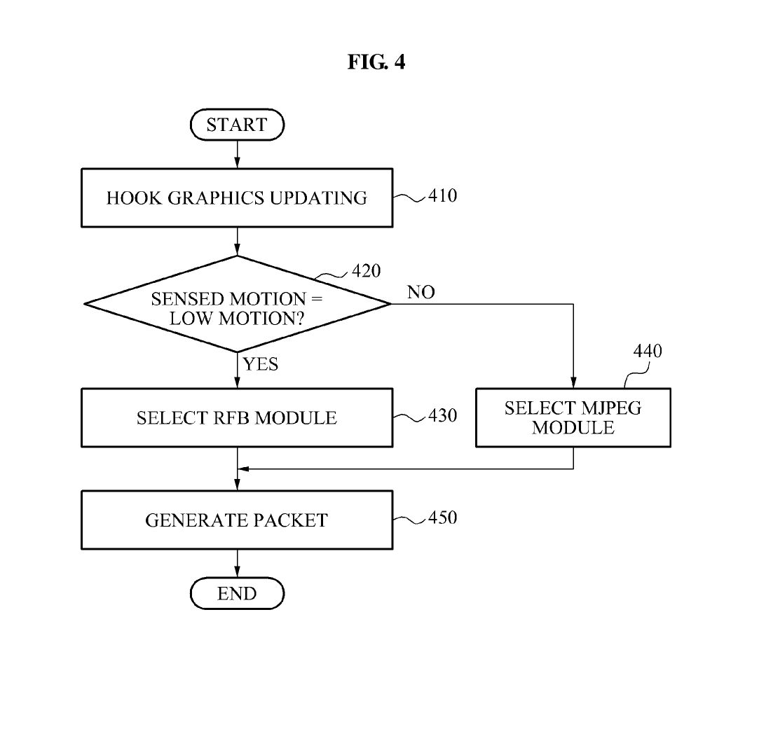

FIG. 4 is a flowchart illustrating an operation method of a hybrid protocol according to an embodiment.

A codec for transmitting content to a terminal may provide efficient compression and low latency.

The hybrid protocol may use a combination of a thin-client protocol, an RFB protocol, and an MJPEG protocol in order to transmit graphics output to the terminal

The hybrid protocol may include the following operations 410 through 450.

In operation 410, graphics updating at a graphics card hardware frame buffer may be hooked. Here, graphics updating may indicate changing a screen of the content.

In operation 420, an encoding module suitable for video encoding may be determined by a motion detector. Switching of the encoding module may be transparent to a user. For example, the user of the terminal may view the content without recognizing switching of the encoding module. When a sensed motion corresponds to a low motion, operation 430 may be performed. Otherwise, operation 440 may be performed. Here, the sensed motion may correspond to the screen change of FIG. 3.

When the sensed motion is the low motion, an RFB module using a relatively small amount of resources may be selected as a remote display module in operation 430.

When the sensed motion is a high motion, an MJPEG module may be selected as the remote display module for real-time encoding. Compared to MPEG encoding, MJPEG encoding may use a relatively small amount of resources for calculation. Also, MJPEG encoding may provide flexible compression during a runtime.

In operation 450, by employing a module selected from between the MJPEG module and the RFB module, a packet to transmit the content may be generated.

The units described herein may be implemented using hardware components and software components. For example, microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing a higher level code that may be executed by the computer using an interpreter. The described hardware devices may be configured to act as one or more software modules in order to perform the operations of the above-described exemplary embodiments, or vice versa.

An N-screen service, which is independent and provided as a single platform, may be provided. An N-screen service according to an embodiment may have relatively small restrictions on a place and a terminal and thus, may make contributions to development of the N-screen service and development of a new convergence service.

An N-screen service according to an embodiment may be developed to be a further various and highly useful N-screen service, deviated from an existing N-screen service that is provided as a single platform and thus, may satisfy requirements of a user.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing content at a gateway, the method comprising:
receiving a request for sharing the content from a first terminal;
setting sharing of the content when a first user of the first terminal has a right to share the content;
obtaining the right to share the content from a second terminal of a second user when the first user does not have the right to share the content;
receiving a request for providing the content from a third terminal of a third user;
creating transformed content by applying, to the content, transformation that is suitable for the third terminal and the content, based on content information on the content; and
transmitting the transformed content to the third terminal of the third user.

2. The method of claim 1, wherein the second user is an owner of the content or a user capable of assigning the right to share the content to another user.

3. The method of claim 1, further comprising:
receiving the content from the first terminal; and
storing the received content in a cloud server.

4. The method of claim 1, wherein the content is transmitted from the first terminal to a cloud server via the gateway through synchronization between the first terminal and the gateway.

5. The method of claim 1, further comprising:
receiving the content from a cloud server,
wherein the cloud server provides a cloud service to the first terminal.

6. The method of claim 5, wherein:
the request for sharing the content, which is received from the first terminal, comprises registration information, and
the gateway accesses the cloud server with the right of the first user using the registration information.

7. The method of claim 1, wherein:
the transformed content is transmitted to the third terminal through a hybrid protocol, and
the hybrid protocol is a protocol having a relatively small data transmission amount between a first protocol used when a screen change on the transformed content is great and a second protocol used when the screen change is small.

8. The method of claim 7, wherein the first protocol is a protocol to generate a packet of the content using a motion JPEG (MJPEG) compression, and the second protocol is a protocol to generate the packet using a remote frame buffer.

9. A non-transitory computer-readable recording medium storing a program to implement the method of claim 1.

10. A gateway, comprising:
a networking unit to receive a request for sharing content from a first terminal; and
a processing unit to set sharing of the content when a first user of the first terminal has a right to share the content, and to obtain the right to share the content from a second terminal of a second user when the first user does not have the right to share the content,
wherein the networking unit receives a request for providing the content from a third terminal of a third user and transmits the transformed content to the third terminal of the third user, and
the processing unit creates transformed content by applying, to the content, transformation that is suitable for the third terminal and the content, based on content information on the content.
